(19) United States
(12) Patent Application Publication
(10) Pub. No.: US 2013/0242417 A1
(43) Pub. Date: Sep. 19, 2013

(54) Paper Advertising Apparatus with Magnifier

(71) Applicant: Rick Melgren, Trabuco Canyon, CA (US)

(72) Inventor: Rick Melgren, Trabuco Canyon, CA (US)

(21) Appl. No.: 13/420,597

(22) Filed: Mar. 14, 2012

(51) Int. Cl. G02B 27/02

(52) U.S. Cl. 359/802

(57) ABSTRACT

A paper advertising apparatus with magnifier comprising a main paper piece, a first window disposed on said paper piece, a magnifier disposed within said first window such that an object is visually magnified when a viewer looks at the object through said magnifier. The paper advertising apparatus comprising a magnifier piece that can resemble the shape of eyeglasses.

### BACKGROUND OF THE INVENTION

(1). Field of the Invention

The subject matter described herein generally relates to paper advertising and more particularly relates to a paper advertising apparatus with magnifier.

(2). Description of Related Art

One can appreciate that in today's competitive marketplace, individuals, businesses and companies are always searching for new ways to market their goods and/or services to consumers. Indeed, modernly consumers are bombarded daily with a variety of marketing materials aimed to grab the consumer's attention with the hopes of it translating into business.

Though internet marketing has become increasingly important in today's business world, paper based marketing still remains a very popular choice because it still allows the consumer the ability to physically touch and see the marketing material while being able to be placed in a variety of areas and ways that internet marketing simply cannot accomplish.

Because of the changing economy and businesses/companies concerned about cutting costs, it is imperative that business/companies obtain more value out of their paper based marketing.

Desirable features will become apparent from the subsequent detailed description and the appended claims, taken in conjunction with the accompanying drawings and the foregoing technical field and background.

All referenced patents, applications and literature are incorporated herein by reference to their entirety. Furthermore, where a definition or use of a term in a reference, which is incorporated by reference herein, is inconsistent or contrary to the definition of that term provided herein, the definition of that term provided herein applies and the definition of the term in the reference does not apply. The invention may seek to satisfy one or more of the above-mentioned desires. Although the present invention may obviate one or more of the above-mentioned desires, it should be understood that some aspects of the invention might not necessarily obviate them.

### BRIEF SUMMARY OF THE INVENTION

In view of the foregoing disadvantages inherent in the known types of prior art, the general purpose of the present invention, which will be described subsequently in greater detail, is to provide a paper advertising apparatus with magnifier.

It is a feature of this invention to provide a paper advertising apparatus whereas the shape of the magnification can resemble eye-glasses.

Another feature of this invention is to provide a paper advertising apparatus that adds increased value by providing the utilitarian feature of allowing the user to increase the viewing magnification of whatever he or she is focusing on.

Another feature of this invention is to provide a paper advertising apparatus with magnifier that can customized and tailored to come in a variety of shapes and sizes.

Another feature of the invention is to provide a paper advertising apparatus that is cost-effective to make and can be easily distributed and mass produced.

Another feature of the invention is to provide a method of promoting a message by enticing a viewer to manually pick up a piece of paper having a printed message.

Other details, features, uses, objects and advantages of this invention will become apparent from the embodiments thereof presented in the following specification, claims, and drawings.

This summary is provided to introduce a selection of concepts in a simplified form that are further described below in the detailed description. This summary is not intended to identify key features or essential features of the claimed subject matter; nor is it intended to be used as an aid in determination the scope of the claimed subject matter.

### DESCRIPTION OF THE DRAWING(S)

Various other objects, features and advantages of the present invention will become fully appreciated as the same becomes better understood when considered in conjunction with the accompanying drawings, in which like reference characters designate the same or similar parts throughout the several views, and wherein:

FIG. 1 shows a first embodiment where the paper advertising apparatus with magnifier subject matter of the present invention is a one-piece paper insert with the viewing magnifier resembling eyeglasses.

FIG. 2 shows two types of embodiments where the paper advertising apparatus with magnifier subject matter of the present invention can be a one-piece insert with the viewing magnifier resembling eyeglasses or having a normal viewing magnifying window.

FIG. 3 shows a third embodiment where the paper advertising apparatus with magnifier subject matter of the present invention can be in the form of folded stand that can stand alone or fitted inside a typical plastic display stand.

FIG. 4 shows the same embodiment of FIG. 3 being in a slightly opened position.

FIG. 5 shows the same embodiment of FIG. 3 being fully spread apart.

FIG. 6 shows the same embodiment of FIG. 3 being fully spread apart and showing the underside with viewing magnifier resembling eyeglasses in place.

FIG. 7 shows the same embodiment of FIG. 3 being fully spread apart and showing the underside with viewing magnifier resembling eyeglasses sliding into place.

FIG. 8 shows a cross-sectional view of the magnifying element in relation to the pocket and viewing windows.

FIG. 9 shows the same embodiment of FIG. 3 being fully spread apart and showing the underside with viewing two different types of embodiments of the magnifier resembling eyeglasses bring glued into place.

### DESCRIPTION OF AN EXEMPLARY EMBODIMENT

The following detailed description is merely exemplary in nature and is not intended to limit the inventive subject matter or the application and uses of the inventive subject matter. Furthermore, there is no intention to be bound by any theory presented in the preceding background or the following description. Techniques and technologies may be described herein in terms of functional and/or logical block components and various processing steps. It should be appreciated that such block components may be realized by any number of hardware, software, and/or firmware components configured to perform the specified functions. In addition, those skilled in the art will appreciate that embodiments may be practiced in conjunction with any number of ways and that the apparatus and method described herein is merely one suitable example.

Many alterations and modifications may be made by those having ordinary skill in the art without departing from the spirit and scope of the invention. Therefore, it must be understood that the exemplary embodiment has been set forth only for the purposes of example and that it should not be taken as limiting the invention as defined by the following claims. For example, notwithstanding the fact that the elements of a claims are set forth below in a certain combination, it must be expressly understood that the invention includes other combinations of fewer, more or different elements, which are disclosed herein even when not initially claimed in such combinations.

Furthermore, the connecting lines shown in the various figures contained herein are intended to represent example functional relationships and/or physical couplings between the various elements. It should be noted that many alternative or additional functional relationships or physical connections may be present in an embodiment of the subject matter.

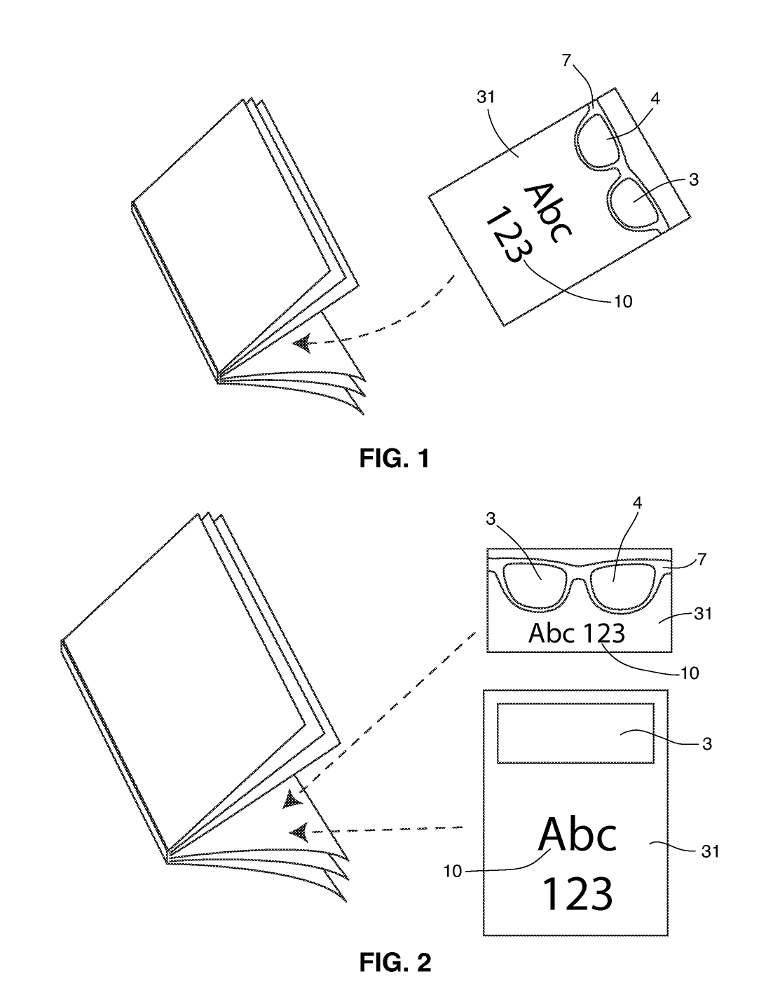

Referring now to the drawings, which are provided by way of illustration and example, and wherein like reference numerals designate like or corresponding elements among the several views, there is shown in FIG. 1, a paper advertising apparatus with magnifier comprising a first section 31 containing a printed message 10. Said first section 31 containing one embodiment of the magnifier 7 being in the shape of eyeglasses and having a plurality of viewing of a first window 3 and a second window 4. In this embodiment shown in FIG. 1, the subject matter of the present invention can easily be inserted into a variety of items such as newspapers, magazines, menus, programs etc., making it very accessible. Since typically the font size of the above listed printed mediums can be sometimes small and hard to read, in typical use, the user would use the paper advertising apparatus with magnifier subject matter of the present invention to increase the viewing magnification of the reading area of interest. A noted advantage of the paper advertising apparatus with magnifier subject matter of the present invention is that it allows for a printed message 10 to be included underneath said magnifier making the subject matter of the present invention an excellent medium for advertisement of any printed message. One can appreciate that the paper advertising apparatus with magnifier subject matter of the present invention can also include a plurality of perforations (not shown) in which allows the user to tear off certain sections of the printed message for such things as business cards, coupons and similar items. As shown in FIG. 2, the magnifier element 3 of the paper advertising apparatus subject matter of the present invention shown in FIG. 1 can resemble an eyeglass or be in the form of a large regular shaped window 3.

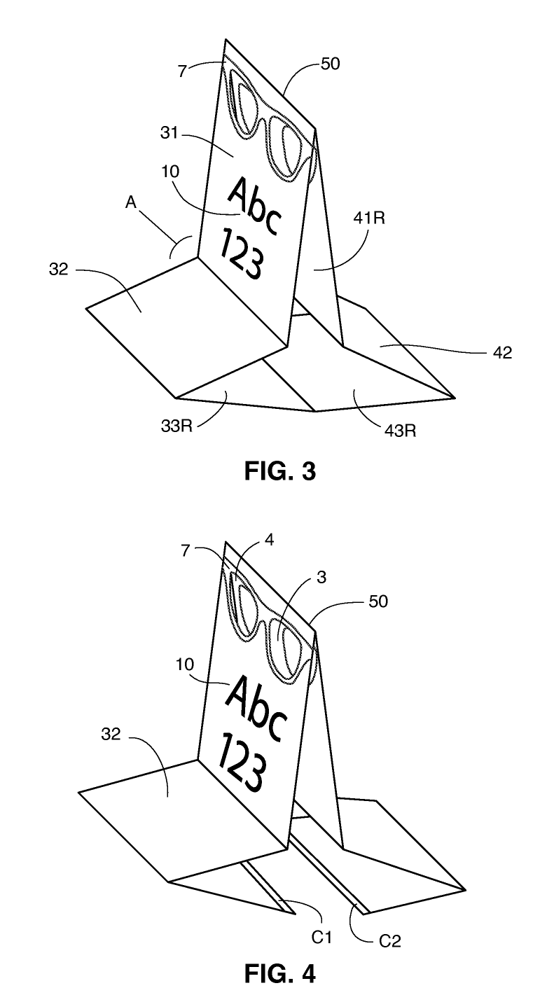

As clearly seen in FIG. 3, another embodiment of the paper advertising apparatus subject matter of the present invention can be in the form of a type of folded stand 50 comprising a first section 31, a second section 32, and a third section 33 (not shown but reverse side 33R is shown). In similar fashion to the paper insert embodiment shown in FIG. 1, the folded stand 50 embodiment provides the advantage of having printed medium 10 being incorporated into the first section 31 and also still includes the magnifier 7 that can resemble eyeglasses. However, the folded stand 50 would be more popular in typical use in such places where there are fixtures such as tables, booths, desks or any flat surfaces that would allow the placement of a folded stand.

In order for the folding stand 50 embodiment of the paper advertising apparatus subject matter of the present invention to function, it comprises a plurality of creases that can be connected together to form a stable base as shown by numerals C1 and C2 in FIG. 4.

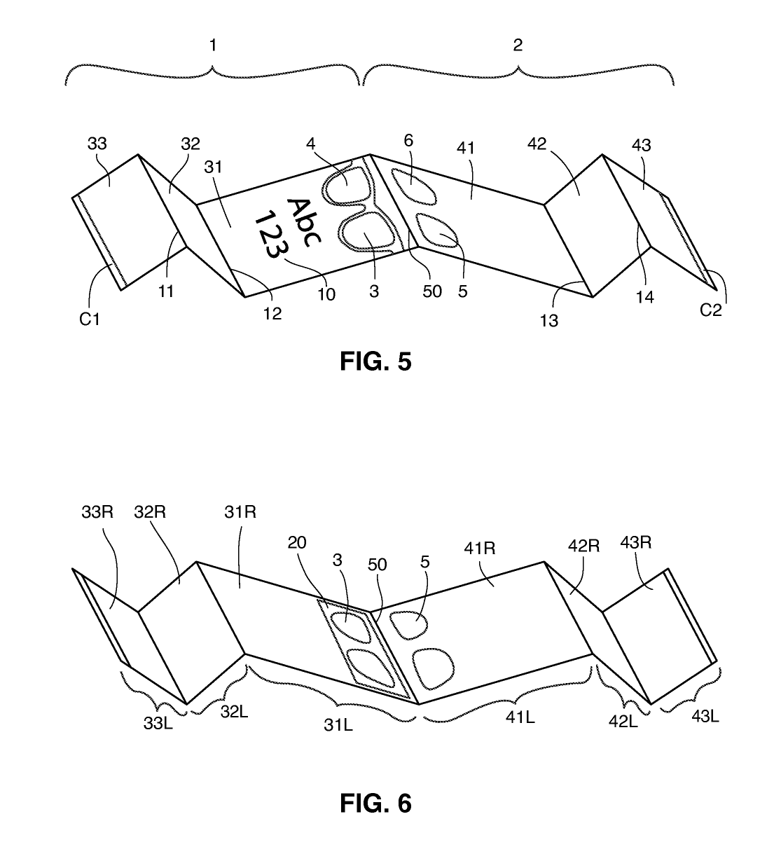

To fully appreciate the paper advertising apparatus subject matter of the present invention in a folded stand 50 embodiment, FIG. 5 depicts an embodiment of the folded stand 50 spread apart comprising of a first portion 1, second portion 2, a plurality of windows (3, 4, 5, 6), printed message 10, and a plurality of creases (11, 12, 13, 14). The plurality of creases divides the first folding portion 1 into a first section 31, a second section 32, and a third section 33. The plurality of creases also divides the second folding portion 2 into a first section 41, a second section 42, and a third section 43. The first portion 1 and section portion 2 are connected by the connection points C1 and C2.

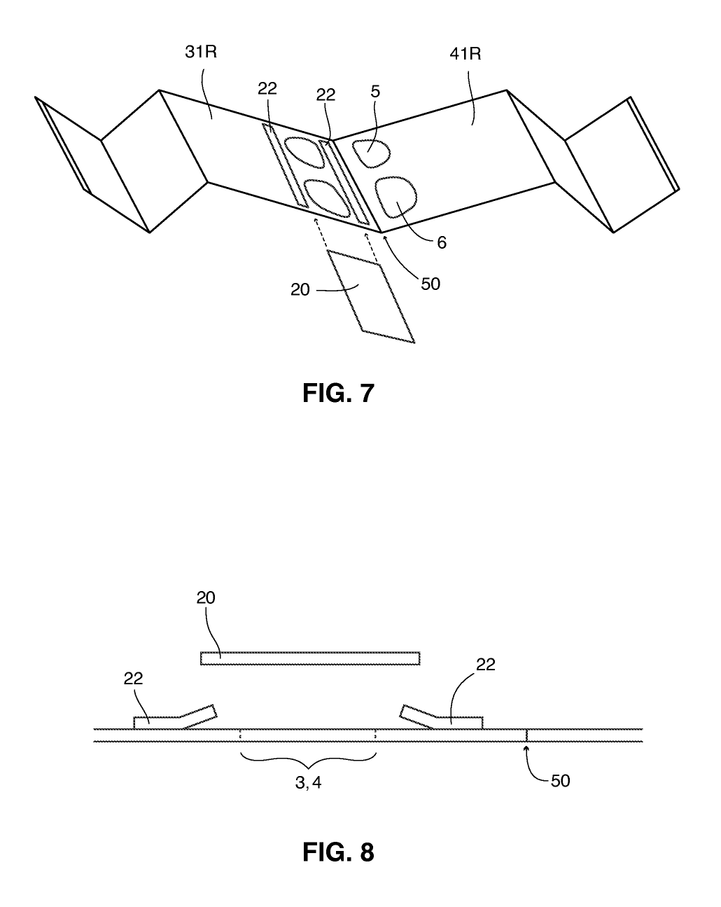

FIG. 6 depicts the reverse or underside of the same embodiment of FIG. 5. In particular, the reverse sides of said first, second and third sections are referenced as (31R, 32R, 33R, and 41R, 42R, 43R respectively). Also seen in FIG. 6, is a magnifying strip 20 which provides the functionality of increasing the viewing magnification of desired area of concern. As seen in FIG. 7, in a present embodiment of the present invention the magnifier element can be in the form of a magnifying strip 20 which can be coupled to the folded stand 50 by a pocket 22 which securely holds the magnifying strip 20 in position relative to the viewing windows (3,4,5,6). Turning to FIG. 8, a cross-sectional view of the magnifying strip 20 is shown in relation to the pocket 22 and the viewing windows 3, 4 and a pivoting structure 50.

Therefore FIGS. 6, 7 and 8 shows an inherent advantage the paper advertising apparatus subject matter of the present invention in a folded stand format which involves a convenient and cost-effective way to manufacture the folded stand in a one-piece die cut manner and having the magnifier element be manufactured separately thereby allowing the easy method of replacing the magnifying element if damaged or if a greater viewing magnification is desired.

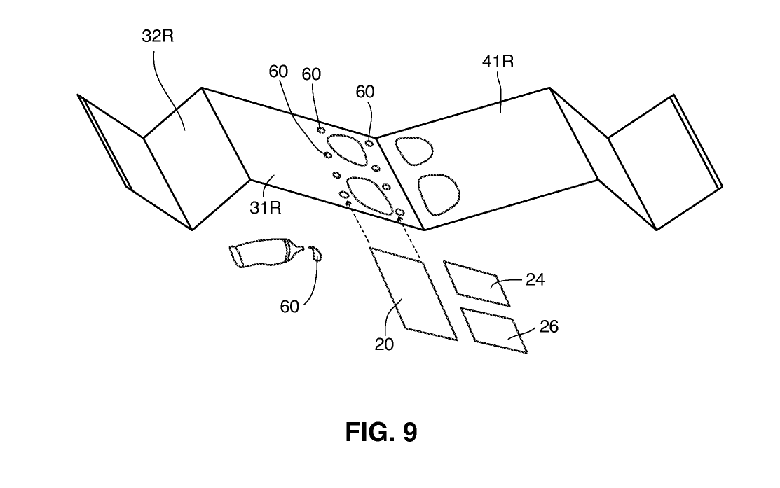

FIG. 9 illustrates an alternative embodiment of coupling the magnifying element onto the folding stand 50 embodiment of the paper advertising apparatus subject matter of the present invention. Here, the magnifying element can be in the form of the said magnifying strip 20 or be in a plurality of magnifying lenses 24 and 26 respectively. In this embodiment, the magnifying element, in either forms (strip 20 or plurality of lenses 24, 26) can be coupled to the reverse side of the first portion 31R by glue 60 or another similar type of adhesion material.

All exemplary illustrations also show a method of promoting a message enticing a viewer to manually pick up a piece of paper having a printed message. For example, whether the paper advertising apparatus subject matter of the present invention is in the form of a paper insert or a folder stand, the present invention invites a typical user to pick up and manually use the magnifier to increase the viewing magnification of an desired area thereby increasing the chances that the user will notice the printed message on the paper insert and/or folded stand. Having the magnifier be resemble eyeglasses in some embodiments only reinforces the desire of the user to pick up the paper insert and/or folded stand and use it as a viewing magnification apparatus and increases the novelty of the apparatus and method of promoting the message contained in the apparatus.

Thus, specific embodiments and applications of the have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A paper advertising apparatus with magnifier, comprising:
a main paper piece;
a first window disposed on said paper piece;
a magnifier disposed within said first window such that an object is visually magnified when a viewer looks at the object through said magnifier.

2. The paper advertising apparatus with magnifier of claim 1, further comprising:
a first folding portion;
a second folding portion;
wherein the first folding portion is the main paper piece, and the second folding portion having a second window;
wherein both the first folding portion and the second folding portion having a plurality of folding creases;
wherein the plurality of folding creases divides the first folding portion and the second folding portion each into a first section, a second section, and a third section;
wherein the first window is disposed on the first section of the first folding portion;
wherein the second window is disposed on the first section of the second folding portion;
wherein the first section of the first folding portion and the first section of the second folding portion are connected to form a pivoting structure.
the first window and the second window having identical apertures.

3. The paper advertising apparatus with magnifier of claim 2, wherein the magnifier is inserted into a pocket disposed on a reverse side of the first section of the first folding portion.

4. The paper advertising apparatus with magnifier of claim 3, wherein the magnifier is a magnifying strip or a magnifying lens attached to the first window and the second window by an adhesive.

5. The paper advertising apparatus with magnifier of claim 2, wherein the first section, the second section and the third section of the first folding portion and the second folding portion each having a lateral side perpendicular to the plurality of creases, and the lateral side of the first section, the lateral side of the second section and the lateral side of the third section having a ratio of 5:1:2, respectively.

6. The paper advertising apparatus with magnifier of claim 5, wherein the first folding portion further comprises a third window, wherein the second folding portion further comprises a fourth window, wherein the third window and the fourth window are oval and resemble a shape of eye-glasses.

7. The paper advertising apparatus with magnifier of claim 6, wherein the first folding portion and the second folding portion are one integral piece, wherein the pivoting structure is a crease dividing the integral piece into two halves with equal length.

8. The paper advertising apparatus with magnifier of claim 7, wherein the third section of the first folding portion and the third section of the second folding section are connected to form a base of a stand.

9. The paper advertising apparatus with magnifier of claim 8, wherein the first section and the second section of the first folding portion, and the first section and the second section of the second folding portion both form obtuse angles.

10. A paper advertising apparatus with magnifier, comprising:
a paper insert having a center crease;
a first window and a second window; and
a plurality of folding creases;
wherein the center crease divides the paper insert into a first folding portion and a second folding portion;
wherein the first folding portion and the second folding portion having equal longitudinal length and surface area;
wherein the first folding portion pivots relatively to the second folding portion at the center crease;
wherein the first window is disposed on the first folding portion and the second window is disposed on the second folding portion;
wherein the plurality of folding creases divides the first folding portion and the second folding portion each into a first section, a second section, and a third section;
wherein the first window and the second window are disposed proximal to the center crease;
wherein the first window is coupled with a magnifier.

11. The paper advertising apparatus with magnifier of claim 10, wherein the first window and the second window have identical apertures.

12. The paper advertising apparatus with magnifier of claim 11, wherein the magnifier is inserted into a pocket disposed on a reverse side of the first section of the first folding portion.

13. The paper advertising apparatus with magnifier of claim 12, wherein the magnifier is a magnifying strip or a magnifying lens attached to the first window and the second window by an adhesive.

14. The paper advertising apparatus with magnifier of claim 10, wherein the first section, the second section and the third section of the first folding portion and the second folding portion each having a lateral side perpendicular to the plurality of creases, and the lateral side of the first section, the lateral side of the second section and the lateral side of the third section having a ratio of 5:1:2, respectively.

15. The paper advertising apparatus with magnifier of claim 14, wherein the first folding portion further comprises a third window, wherein the second folding portion further comprises a fourth window, wherein the third window and the fourth window are oval and resemble a shape of eye-glasses.

16. The paper advertising apparatus with magnifier of claim 14, wherein the third section of the first folding portion and the third section of the second folding section are connected to form a base of a stand.

17. The paper advertising apparatus with magnifier of claim 16, wherein the first section and the second section of the first folding portion, and the first section and the second section of the second folding portion both form obtuse angles.

18. A method of promoting a message by enticing a viewer to manually pick up a piece of paper having a printed message, said method comprising:
providing a piece of paper having a printed message disposed on said piece of paper;
providing a framed space disposed on the piece of paper;
providing a magnifying transparent window disposed in said framed space, wherein said magnifying transparent window visually magnifies an object when a viewer looks at the object through said transparent window.

19. The method as recited in claim 18, wherein said printed message is a printed advertisement to promote at least one of services, goods, and social agenda.

20. The method as recited in claim 19 further comprising placing said piece of paper within pages of a printed material, wherein said printed material is selected from a group consisting of a book, a menu, a magazine, and a newspaper; and wherein the framed space is illustrated as an eye glasses frame providing two openings for magnifying transparent window.

21. The method as recited in claim 19 further comprising folding said piece of paper into a stand such that piece paper can stand upright on a folded base, and wherein the magnifying transparent window is disposed on a topmost position of the stand.
